(19) United States
(12) Patent Application Publication
(10) Pub. No.: US 2003/0176568 A1
(43) Pub. Date: Sep. 18, 2003

(54) High-solids coating composition

(76) Inventors: Hiroyuki Onoda, Atsugi-shi (JP); Kazutoshi Sugiura, Yokohama-shi (JP); Yoshizumi Matsuno, Hadano-shi (JP); Hisashi Isaka, Atsugi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/384,676

(22) Filed: Mar. 11, 2003

(30) Foreign Application Priority Data
Mar. 12, 2002 (JP) 2002-66916

(51) Int. Cl. C08K 3/00

(52) U.S. Cl. 524/589

(57) ABSTRACT

This invention relates to a high-solids coating composition which characteristically comprises:

(A) at least one species of base resin component which is selected from the group consisting of hydroxyl group-containing compound (A-1) which is obtained from a reaction between carboxyl group-containing compound and epoxy group-containing compound, and which has a weight average molecular weight of 1000 or less and a hydroxyl value of 200 to 800 mgKOH/g, and hydroxyl group-containing resin (A-2) which has a weight average molecular weight of 500 to 6000 and a hydroxyl value of 50 to 600 mgKOH/g,

(B) at least one species of curing agent component which is selected from the group consisting of polyisocyanate compound (B-1) and melamine resin (B-2), and

(C) at least one species of thixotropic properties-giving component which is selected from the group consisting of organic clay type thickening agent and silica fine particles.

This invention relates to a novel high-solids coating composition, and also to a process to form a multi-layered coating film with use of said composition.

The reduction of the amount of organic solvent used has been one of important objectives in the field of coating composition, from the viewpoint of environmental protection against air pollution and of the saving of resources. As a means to achieve this objective, there has been developed so-called “high-solids coating composition”, i.e., an organic solvent type paint wherein the amount of organic solvent contained in paint is reduced to increase solids content.

Most of high-solids coating compositions which are now being proposed comprise hydroxyl group-containing resin as a base resin and, compounded therewith, melamine resin as a curing agent. However, when it is tried to reduce the molecular weight of base resin and to thereby render the resultant paint low-viscous, so that solids content in the paint can be increased, there occurs a grave defect that thus obtained coating film becomes poor in coating film performance. When a large amount of cross-linking functional groups such as hydroxyl group is introduced into a base resin in a low-molecular state so that coating film performance may be maintained, with a view to avoiding said defect, the viscosity of resin increases so high by interaction among said functional groups that it becomes difficult to render the paint low-viscous. Furthermore, when a large amount of melamine is compounded, by-products such as alcohol are produced in abundance at the time of heat-curing, with the result that popping (foaming) is apt to occur on the coating film.

A cured coating film of top coating containing melamine resin as a curing agent which has been applied on substrate to be used outdoors such as automobile exterior panels has defects that acid rain often leaves etching or stains, and that car-washing machine easily makes scratches. Polyisocyanate compound, on the other hand, has usually lower viscosity than melamine resin, and therefore serves well to form high-solids paint. Moreover, a cured coating film which has been formed from a paint containing polyisocyanate compound as a curing agent is excellent in acid rain resistance, car-washing machine scratch resistance and also in appearance (e.g., gloss, fatness and distinctness-of-image gloss). Said coating film has, however, a defect that, in a high-concentration domain where solids content is 70% by weight or more, the hardness of cured coating film is insufficient.

There is also another problem that, when these high-solids coating compositions are applied by fogging method such as spray coating and electrostatic coating to a large thickness e.g., to a thickness of 50 μm or more, by a single application, the resultant coating film is apt to sag to damage appearance such as smoothness.

The objective of this invention is to provide a novel high-solids coating composition which is free from the above-mentioned defects of conventional techniques, has low viscosity, can be applied to large thickness, and which is capable of forming a coating film excellent in coating film performances such as appearance, coating film hardness, acid rain resistance and scratch resistance. To provide a process to form a multi-layered coating film with use of this coating composition is also an objective of this invention.

As a result of assiduous study, inventors of this invention have found out that a coating composition which comprises a specific hydroxyl group-containing compound or resin, a polyisocyanate resin or melamine resin as a curing agent and organic clay type thickening agent and/or silica fine particles achieves the above-mentioned objective, and thus have completed this invention.

This invention provides a high-solids coating composition (hereinafter referred to as “the present composition”) which characteristically comprises:

(A) at least one species of base resin component which is selected from the group consisting of hydroxyl group-containing compound (A-1) which is obtained from a reaction between carboxyl group-containing compound and epoxy group-containing compound, and which has a weight average molecular weight of 1000 or less and a hydroxyl value of 200 to 800 mgKOH/g, and hydroxyl group-containing resin (A-2) which has a weight average molecular weight of 500 to 6000 and a hydroxyl value of 50 to 600 mgKOH/g,

(B) at least one species of a curing agent component which is selected from the group consisting of polyisocyanate compound (B-1) and melamine resin (B-2), and

(C) at least one species of thixotropic properties-giving component which is selected from the group consisting of organic clay type thickening agent and silica fine particles.

This invention further provides a method (hereinafter referred to as “the present method”) of forming a multi-layered coating film which comprises at least one layer of colored coating film and at least one layer of clear coating film, wherein the uppermost layer of clear coating film is formed by the application of the present composition.

In the following, the present composition and the present method of this invention are explained in more detail.

### THE PRESENT COMPOSITION

The present composition is an organic solvent type high-solids coating composition which comprises (A) a base resin component, (B) a curing agent component and (C) a thixotropic properties-giving component. When applied, this composition may have a solids content of 70% by weight or more, in particular in a range of 75 to 90% by weight.

(A) A Base Resin Component:

The present composition uses, as a base resin component, at least one species of base resin component which is selected from the group consisting of hydroxyl group-containing compound (A-1) which is obtained from a reaction between carboxyl group-containing compound and epoxy group-containing compound, and which has a weight average molecular weight of 1000 or less and a hydroxyl value of 200 to 800 mgKOH/g, and hydroxyl group-containing resin (A-2) which has a weight average molecular weight of 500 to 6000 and a hydroxyl value of 50 to 600 mgKOH/g.

Hydroxyl group-containing compound (A-1) is a product from a reaction between carboxyl group-containing compound and epoxy group-containing compound, and can be prepared by oxirane ring-opening esterification reaction between carboxyl group of carboxyl group-containing compound and epoxy group of epoxy group-containing compound.

Hydroxyl group-containing compound (A-1) may contain hydroxyl group which is derived from raw material compounds as well as hydroxyl group which is formed by the ring opening of epoxy group.

The above-mentioned carboxyl group-containing compound is a compound which has at least one carboxyl group per molecule. Examples of this compound include monocarboxylic acid such as acetic acid, propionic acid, butyric acid, 2-ethylhexanoic acid, octanoic acid, dodecanoic acid, palmitic acid, stearic acid, oleic acid, pivalic acid, versatic acid and benzoic acid; polycarboxylic acid such as succinic acid, adipic acid, azelaic acid, sebacic acid, dodecanedioic acid, tetrahydrophthalic acid, phthalic acid, butanetricarboxylic acid, butanetetracarboxylic acid and trimellitic anhydride; and hydroxycarboxylic acid such as glycolic acid, lactic acid, malic acid, citric acid, tartaric acid, hydroxypivalic acid, dimethylolpropionic acid, dimethylolbutanoic acid and gluconic acid. Anhydrides of these carboxylic acids are also usable. There are also usable a product from a reaction between said anhydrides and glycols, e.g., a product from a reaction between trimethylolpropane and hexahydrophthalic anhydride, and between trimethylolpropane and succinic anhydride. Preferable among the above are hydroxycarboxylic acid wherein both hydroxyl group and carboxylic acid exist, and a reaction products from a reaction between anhydride and glycol, since hydroxycarboxylic acid and said reaction products are capable of introducing a large amount of hydroxyl groups into compound (A-1). In particular desirable is hydroxycarboxylic acid.

The above-mentioned epoxy group-containing compound is a compound which has at least one epoxy group per molecule. As such a compound, there is usable any known one, from among those which are mentioned in (i) to (iv) below:

(i) glycidol,

(ii) an epoxy group-containing compound which is obtained from an etherification reaction between a hydroxyl group-containing compound and epihalohydrin,

(iii) an epoxy group-containing compound which is obtained from an esterification reaction between a carboxyl group-containing compound and epihalohydrin, and

(iv) an epoxy group-containing compound which is obtained from a reaction between an unsaturated group-containing compound and a peroxide.

Glycidol of the above (i) is 2,3-epoxy-1-propanol, and is obtained from, for instance, a reaction between allylalcohol and benzoic acid, or between tungstic acid and hydrogen peroxide.

Examples of hydroxyl group-containing compound which is used for the production of the epoxy group-containing compound of the above (ii) include aromatic hydroxyl group-containing compound such as phenol, bisphenol A, bisphenol F, phenolic novolak resin, orthocresol novolak resin and bromides thereof, alicyclic hydroxyl group-containing compound such as bisphenol A hydride; aliphatic monoalcohol having 1 to 20 carbon atoms such as methanol, ethanol, propanol and octanol; and aliphatic polyol having 2 to 20 carbon atoms such as ethylene glycol, prpoylene glycol, hexanediol, diethylene glycol, neopentyl glycol, glycerin, trimethylolpropane, pentaerythrite and dipentaerythrite. As epihalohydrin which is to be made to react with the above-mentioned hydroxyl group-containing compounds, epichlorohydrin is in particular suitable. Etherification reaction between a hydroxyl group-containing compound and epihalohydrin may be conducted by any known method. This reaction gives any desired epoxy group-containing compound of the above (ii).

Examples of products on the market which correspond to the above-mentioned epoxy group-containing compound include “Denacol EX-313”, “Denacol EX-321”, “Denacol EX-421” and “Denacol EX-611” (all of which are trademarks of products manufactured by Nagase Chemicals Ltd.).

Suitable examples of carboxyl group-containing compound and epihalohydrin which are used for the production of the epoxy group-containing compound of the above (iii) are the carboxyl group-containing compounds which are mentioned above as raw material compounds for hydroxyl group-containing compound (A-1) and epichlorohydrin. Esterification reaction between a carboxyl group-containing compound and epihalohydrin may be conducted by any known method. This reaction gives any desired epoxy group-containing compound of the above (iii). Examples of products on the market which correspond to such an epoxy group-containing compound include “Cardura E10” (trademark of a product manufactured by Shell Oil Company), “Glydexx N10” (trademark of a product manufactured by Exxon Co.) and “Araldite PT910” (trademark of a product manufactured by Ciba-Geigy).

As the epoxy group-containing compound of the above (iv), there may be used products on the market such as “Celoxide 2021” and “Celoxide 3000” (both of which are trademarks of products manufactured by Daicel Chemical Industries, Ltd.).

Among the above-mentioned epoxy group-containing compounds, there is preferably used the epoxy group-containing compound of the above (iii), in particular glycidyl ester which has a hydrophobic group.

Ring-opening esterification reaction between carboxyl group-containing compound and epoxy group-containing compound for the production of hydroxyl group-containing compound (A-1) proceeds also at room temperature. Generally, however, said reaction is preferably conducted with heating to 100 to 160° C., suitably 115 to 150° C., with use of no catalyst, in the presence or absence of solvent.

Thus obtained hydroxyl group-containing compound (A-1) has at least two hydroxyl groups, and a weight average molecular weight of 1000 or less, preferably 300 to 700, and a hydroxyl value of 200 to 800 mgKOH/g, preferably 300 to 600 mgKOH/g. When the weight average molecular weight of hydroxyl group-containing compound (A-1) is more than 1000, it becomes difficult to form high-solids paint. When hydroxyl value is lower than 200 mgKOH/g, coating film becomes poor in curability, while, when it is higher than 800 mgKOH/g, compatibility with polyisocyanate compound tends to lower.

In particular preferable as hydroxyl group-containing resin (A-2) is a resin such as hydroxyl group-containing polyester resin and hydroxyl group-containing acrylic resin, which has a weight average molecular weight of 500 to 6000 and a hydroxyl value of 50 to 600 mgKOH/g.

The above-mentioned hydroxyl group-containing polyester resin can be produced by esterification reaction between carboxyl group of polybasic acid and hydroxyl group of polyhydric alcohol by a usual method. The above-mentioned polybasic acid is a compound which has at least two carboxyl groups per molecule. Examples of such a polybasic acid include phthalic acid, isophthalic acid, terephthalic acid, succinic acid, adipic acid, azelaic acid, sebacic acid, tetrahydrophthalic acid, hexahydrophthalic acid, HET acid, maleic acid, fumaric acid, itaconic acid, trimellitic acid, pyromellitic acid, and anhydride thereof. The above-mentioned polyhydric alcohol is a compound which has at least two hydroxyl groups per molecule. Examples of such a polyhydric alcohol include α-alcohol such as ethylene glycol, 1,2-propylene glycol, 1,2-butylene glycol, 2,3-butylene glycol, 1,2-hexanediol, 1,2-dihydroxycyclohexane, 3-ethoxypropane-1,2-diol and 3-phenoxypropane-1,2-diol; and neopentylglycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, 2-ethyl-1,3-octanediol, 1,3-dihydroxycyclohexane, 1,4-butanediol, 1,4-dihydroxycyclohexane, 1,5-pentanediol, 1,6-hexanediol, 2,5-hexanediol, 3-methyl-1,5-pentanediol, 1,4-dimethylolcyclohexane, tricyclodecane dimethanol, 2,2-dimethyl-3-hydroxypropyl-2,2-demethyl-3-hydroxypropionate (which is produced by esterification reaction between hydroxypivalic acid and neopentylglycol), bisphenol A, bisphenol F, bis(4-hydroxyhexyl)-2,2-propane, bis(4-hydroxyhexyl)methane, 3,9-bis(1,1-dimethyl-2-hydroxyethyl)-2,4,8,10-tetraoxaspiro-[5,5]undecane, diethylene glycol, triethylene glycol, glycerin, diglycerin, triglycerin, pentaerythritol, dipentaerythritol, sorbitol, mannitol, trimehylolethane, trimethylolpropane, ditrimethylolpropane and tris(2-hydroxyethyl)isocyanurate.

The introduction of hydroxyl group into polyester resin can be conducted with use of dihydric alcohol which has two hydroxyl groups per molecule and polyhydric alcohol which has three hydroxyl groups per molecule, in combination.

Hydroxyl group-containing acrylic resin can be produced by the copolymerization of hydroxyl group containing polymeric monomer and acrylic monomer by a usual method.

Hydroxyl group-containing polymeric monomer is a compound which has at least one hydroxyl group and at least one polymeric unsaturated bond per molecule. Examples of said hydroxyl group-containing polymeric monomer include a monoesterified compound from C₂-C₂₀ glycol and (meth)acrylic acid, such as hydroxyethyl (meth)acrylate, hydroxypropyl (meth)acrylate and hydroxybutyl (meth)acrylate. Acrylic monomer include a monoesterified compound from (meth)acrylic acid and C₁-C₂₂ monohydric alcohol. As examples of such acrylic monomer, there can be mentioned methylacrylate, methylmethacrylate, ethylacrylate, ethylmethacrylate, propylacrylate, propylmethacrylate, butylacrylate, butylmethacrylate, hexylacrylate, hexylmethacrylate, octylacrylate, octylmethacrylate, laurylacrylate, laurylmethacrylate, 2-ethylhexylacrylate, 2-ethylhexylmethacrylate, cyclohexyl(meth)acrylate and isobornyl(meth)acrylate.

For the production of hydroxyl group-containing acrylic resin, there can be used together other polymeric monomer than the above-mentioned hydroxyl group containing polymeric monomer and acrylic monomer.

Examples of said other monomer include C₂-C₁₈ alkoxyalkyl (meth)acrylate such as methoxybutyl acrylate, methoxybutyl methacrylate, methoxyethyl acrylate and methoxyethyl methacrylate; aminoacrylic monomer such as N,N-dimethylaminoethylacrylate, N,N-dimethylaminoethylmethacrylate, N,N-diethylaminoethylacrylate, N,N-diethylaminoethylmethacrylate, N-t-butylaminoethylacrylate, N-t-butylaminoethylmethacrylate, N,N-dimethylaminopropylacrylate and N,N-dimethylaminopropylmethacrylate; acrlylamide monomer such as acrylamide, methacrylamide, N-methylacrylamide, N-methylmethacrylamide, N-ethylacrylamide, N-ethylmethacrylamide, N-butylacrylamide, N-butylmethacrylamide, N,N-dimethylacrylamide and N,N-dimethylmethacrylamide; glycidyl group-containing monomer such as glycidyl acrylate and glycidyl methacrylate; carboxyl group-containing polymeric monomer such as acrylic acid, methacrylic acid, maleic acid, itaconic acid, fumaric acid and mesaconic acid and anhydride or half-esterified compound of these monomers: vinyl aromatic compound such as styrene, α-methylstyrene and vinyltoluene; acrylonitrile, vinylacetate, “Veoba 9” and “Veoba 10” (both of these two are trademarks of products manufactured by Shell Oil Company), and vinylchloride.

Hydroxyl group-containing denatured oligomer which is obtained from a ring-opening esterification reaction between a polyhydric alcohol which has at least two hydroxyl groups per molecule and lactones can also be used as hydroxyl group-containing resin (A-2). Examples of products on the market corresponding to said hydroxyl group-containing denatured oligomer include “TONE 0200 Polyol”, “TONE 0301 Polyol” and “TONE 0305 Polyol” (which are trademarks of products of Union Carbide Corporation), and “PLACCEL 205”, “PLACCEL 303” and “PLACCEL 305” (which are trademarks of products of Daicel Chemical Industries, Ltd.).

Hydroxyl group-containing resin (A-2) may have a weight average molecular weight of 500 to 6000, preferably 1000 to 5200, and a hydroxyl value of 50 to 600 mgKOH/g, preferably 75 to 400 mgKOH/g, in particular desirably 80 to 200 mgKOH/g. When the weight average molecular weight of hydroxyl group-containing resin (A-2) is smaller than 500, thus formed coating film becomes inferior in physical properties. When it is larger than 6000, it becomes difficult to achieve high-solids paint. When hydroxyl value of hydroxyl group-containing resin (A-2) is lower than 50 mgKOH/g, coating film becomes inferior in curability, while, when it is higher than 600 mgKOH/g, compatibility with other components tends to lower.

As base resin component (A) in the present composition, there may be used either at least one species of the above-mentioned hydroxyl group-containing compound (A-1) or at least one species of the above-mentioned hydroxyl group-containing resin (A-2) or a combination of at least one species of the above-mentioned hydroxyl group-containing compound (A-1) and at least one species of the above-mentioned hydroxyl group-containing resin (A-2). Among the above, a combination of hydroxyl group-containing compound (A-1) and hydroxyl group-containing resin (A-2) is preferable. As for the desirable proportion of hydroxyl group-containing compound (A-1) and hydroxyl group-containing resin (A-2) in said combination, hydroxyl group-containing compound (A-1) preferably accounts for 10 to 90% by weight, in particular 30 to 70% by weight, and hydroxyl group-containing resin (A-2) preferably accounts for 90 to 10% by weight, in particular 70 to 30% by weight, on the basis of the weight of total solid content of both of these components.

(B) Curing Agent Component:

As a component by which to crosslink and cure the above-mentioned base resin component (A), the present composition contains at least one species selected from polyisocyanate compound (B-1) and melamine resin (B-2).

Polyisocyanate compound (B-1) is a compound which has at least two free (non-blocked) isocyanate groups per molecule. As this polyisocyanate compound (B-1), there may be used any known polyisocyanate compound, e.g., aliphatic polyisocyanates such as hexamethylene diisocyanate, trimethylhexamethylene diisocyanate, dimer acid diisocyanate and lysine diisocyanate; alicyclic polyisocyanates such as hydrogenated xylylene diisocyanate, cyclohexylene diisocyanate, methylenebis(cyclohexylisocyanate) and isophorone diisocyanate; aromatic polyisocyanates such as tolylene diisocyanate, phenylene diisocyanate, 4,4′-diphenylmethane diisocyanate, xylylene diisocyanate, tetramethylxylylene diisocyanate and naphthalene diisocyanate; organic polyisocyanate compounds of tri- or higher-valence such as 2-isocyanatoethyl-2,6-diisocyanatocaproate, 3-isocyanatomethyl-1,6-hexamethylenediisocyanate and 4-isocyanatomethyl-1,8-octamethylenediisocyanate (so-called triaminononane triisocyanate); dimer or trimer of these polyisocyanate compounds which have at least two isocyanate groups per molecule; and prepolymer which is obtained by a urethane-forming reaction among said polyisocyanate compounds which have at least two isocyanate groups per molecule, polyhydric alcohol, low molecular polyester resin, water, or the like, under a condition of excess isocyanate groups.

As polyisocyanate compound (B-1), there may be used blocked polyisocyanate compound wherein isocyanate group is blocked, together with the above-mentioned non-blocked polyisocyanate compound.

Blocked polyisocyanate compound has a structure that isocyanate group of the above-mentioned polyisocyanate compound is blocked with a blocking agent. Examples of said blocking agent include phenols, oximes, lactams, alcohols, mercaptans and active methylene type compound such as diethyl malonate.

When blocked polyisocyanate compound is to be used together, the proportion of blocked polyisocyanate compound is preferably 50% by weight or less, in particular 30% by weight or less, on the basis of the total amount of non-blocked polyisocyanate compound and blocked polyisocyanate compound.

In general, polyisocyanate compound (B-1) has preferably a number average molecular weight of 2000 or less, in particular 200 to 1000. Aliphatic polyisocyanates and isocyanurates thereof are especially desirable as polyisocyanate compound (B-1).

As an example of melamine resin (B-2), there can be mentioned methylol melamine resin (including those having imino group (>NH) therein) which is obtained by making aldehyde react with a part or all of —NH₂ in melamine. Examples of aldehyde which is used for the reaction to obtain methylol melamine include formaldehyde, paraformaldehyde, acetaldehyde and benzaldehyde. As melamine resin (B-2), there is also usable alkyletherified melamine resin (including those having imino group (>NH) therein) which is produced from etherification reaction between a part or all of methylol group of the above-mentioned methylol melamine resin and alcohol. Examples of alcohol which is used for this etherification include alkanol having 1 to 10 carbon atoms such as methyl alcohol, ethyl alcohol, n-propyl alcohol, isopropyl alcohol, n-butyl alcohol, isobutyl alcohol, 2-ethyl butanol and 2-ethylhexanol. In general, melamine resin has preferably a number average molecular weight of 150 to 3000, in particular 300 to 2000. Melamine resin which has imino group, e.g., Cymel 325 (Mitsui Cytec Co., Ltd.) is in particular preferable since it improves weatherability, especially gloss retention, of coating film.

As component (B), there may be used either polyisocyanate compound (B-1) or melamine resin (B-2), or a combination of these two. Generally, however, a combination of polyisocyanate compound (B-1) and melamine resin (B-2) is preferable. As for the desirable proportion of polyisocyanate compound (B-1) and melamine resin (B-2) which are to be used in combination, polyisocyanate compound (B-1) preferably accounts for 10 to 90% by weight, in particular 30 to 70% by weight, and melamine resin (B-2) accounts for 90 to 10% by weight, in particular 70 to 30% by weight, on the basis of the weight of total solid content of both of these components.

(C) Thixotropic Properties-Giving Component:

The present composition contains at least one species which is selected from organic clay type thickening agent and silica fine particles.

These components are to give thixotropic properties to the present composition. Said components, blended with the present composition, decreases viscosity enough to facilitate such a work as spray coating where high shearing stress is applied to the composition. When, on the other hand, low shearing stress is applied to the composition after it is adhered on substrate, it is possible to raise apparent viscosity. Thixotropic properties-giving component (C) in accordance with the present invention is in particular characterized remarkably in that it can retain viscosity when heat is applied at the time of baking. Owing to this characteristic, not only the occurrence of coating film deficiency such as sagging and cissing can be inhibited when the present composition is to be applied on vertical substrate or in the case of baking after application on vertical substrate, but also the composition can be applied to large thickness. Hence, this component gives rise to a remarkable effect that thus formed coating film has excellent appearance.

As “organic clay type thickening agent”, there may suitably used organic smectite clay, in particular alkylamine derivatives of clay such as montmorillonite and hectorite. Montmorillonite can be represented by an ideal chemical formula:

(Al_{2-y}Mg_{y})Si₄O₁₀(OH)₂.(M⁺, M_{0.5}²⁺)_{y}nH₂O

(M is ion-exchangeable cation, and y=0.2-0.6). Hectorite, on the other hand, includes those which have a compositional formula: (Mg_{3-y}Li_{y})Si₄O₁₀(OH, F)₂.(M⁺, M_{O.5}²⁺)_{y}nH₂O (M is ion-exchangeable cation, and y=0.2-0.6). The above are available as synthetic products or purified products. Purified products may be a mixture. Examples of products on the market which correspond to organic clay type thickening agent include “Bentone 27”, “Bentone 34”, “Bentone 38”, “Bentone SD-1”, “Bentone SD-2”, “Bentone SD-3”, “Bentone 52” and “Bentone 57” (all of which are trademarks of products of Rheox Co.), “Claytone 40”, “Claytone 34”, “Claytone HT” , “Claytone APA”, “Claytone AF” and “Claytone HY” (all of which are trademarks of products of Southern Clay Products Co.), and “Tixogel VP”, “Tixogel TE”, “Tixogel UN”, “Tixogel EZ100”, “Tixogel MP100” and “Tixogel MP250” (all of which are trademarks of products of Sud Chemical Co.). The above-mentioned products are mainly in the form of powders, and may be compounded with the present composition as they are. Desirably, however, they are compounded with the present composition while being mechanically ground.

“Silica fine particles” usually have silanol group on the surface of particles. In the present composition, however, the surface of particles is preferably further treated to be hydrophobic with use of octylsilane or dimethylsilicone oil. Silica fine particles have desirably an average particle size of primary particles of generally 50 nm or less, in particular 30 nm or less. Examples of products on the market which correspond to such silica fine particles include “Aerosil RX200”, “Aerosil R812”, “Aerosil R805”, “Aerosil RY200” and “Aerosil R202” (all of which are trademarks of products of Nippon Aerosil Co., Ltd.). The above-mentioned products are mainly in the form of powders, and may be compounded with the present composition as they are. Desirably, however, they are compounded with the present composition while being mechanically ground.

The present composition comprises the above-mentioned base resin component (A), curing agent component (B) and thixotropic properties-giving component (C) as essential ingredients. The proportion of solid content of each of the components in the present composition is not particularly limited, but may be selected optionally according to the use and the like of the present composition. Generally, however, component (A) suitably accounts for 80 to 20% by weight, in particular 70 to 30% by weight, and component (B) suitably accounts for 20 to 80% by weight, in particular 30 to 70% by weight, each on the basis of total weight of solid content of component (A) and component (B). Component (C), on the other hand, suitably accounts for 0.1 to 10 parts by weight, in particular 0.5 to 5 parts by weight, per 100 parts by total weight of component (A) and component (B) on solid content basis. These components are added to organic solvent for paint, and are uniformly mixed to prepare the present composition,

(D) Rheology Controlling Agent:

If necessary, another rheology controlling agent (D) such as polyurea compound (D-1) and crosslinked polymer fine particles (D-2) may be added to the present composition, together with the above-mentioned thixotropic properties-giving component (C).

As polyurea compound (D-1), there may be mentioned (a) a product from a reaction between diisocyanate compound and benzylamine (U.S. Pat. No. 4,311,622), (b) a solid particulate product from a reaction between polyisocyanate compound and amine compound which has at least one primary amino group (U.S. Pat. No. 4,677,028), etc.

Diisocyanate compound which is used for the production of reaction product (a) is a compound which has two isocyanate groups per molecule, and includes aliphatic, cycloaliphatic and aromatic type ones. In general, this diisocyanate compound has suitably 3 to 40, preferably 4 to 20, carbon atoms. In particular suitable is either symmetric aliphatic or aromatic diisocyanate compound, concrete examples of which include tetramethylene-1,4-diisocyanate, hexamethylene-1,6-diisocyanate, ω,ω′-dipropyletherdiisocyanate, thio-dipropyldiisocyanate, cyclohexyl-1,4-diisocyanate, dicyclohexylmethane-4,4′-diisocyanate, 1,5-dimethyl(2,4-ω-diisocyanatomethylbenzene), 1,5-dimethyl(2,4-ω-diisocyanatoethylbenzene), 1,3,5-trimethyl(2,4-ω-diisocyanatomethylbenzene), 1,3,5-triethyl(2,4-ω)-diisocyanatomethylbenzene), isophoronediisocyanate, dicyclohexyldimethylmethane-4,4′-diisocyanate, 2,4-toluenediisocyanate, 2,6-toluenediisocyanate and diphenylmethane-4,4′-diisocyanate. Among these, hexamethylene-1,6-diisocyanate and toluenediisocyanate are in particular suitable.

In the reaction between diisocyanate compound and benzylamine, one of these two components is preferably used in stochiometric excess. In that case, the ratio of the number of amino groups of benzyl amine to the number of isocyanate groups of diisocyanate compound is suitably in a range of 0.7 to 1.5. This reaction of these two components is desirably conducted in an inert gas atmosphere and at temperature of 10 to 150° C., in particular 20 to 80° C. Furthermore, said reaction is preferably carried out in an inert organic solvent like acetone, methylethylketone, benzene, toluene, xylene and aliphatic hydrocarbon solvent such as petroleum ether.

Polyisocyanate compound which is used for the production of reaction product (b) is a compound which has at least two isocyanate groups per molecule, and includes monomer of polyisocyanate compound and isocyanurate thereof.

Monomer of polyisocyanate compound is polyisocyanate compound which has 3 to 20, preferably 5 to 14, more desirably 8 to 12, carbon atoms, examples of which include methylenediisocyanate, trimethylenediisocyanate, tetramethylenediisocyanate, hexamethylenediisocyanate, ω,ω′-dipropyletherdiisocyanate, thio-dipropyldiisocyanate, cyclohexyl-1,4-diisocyanate, dicyclohexylmethane-4,4′-diisocyanate, 1,5-dimethyl-2,4-bis(isocyanatomethyl)-benzene, 1,5-dimethyl-2,4-bis(ω-isocyanatoethyl)-benzene, 1,3,5-trimethyl-2,4-bis(isocyanatomethyl)benzene, 1,3,5-triethyl-2,4-bis(isocyanatomethyl)benzene, heterocyclic diisocyanate which is being sold by Sumika Bayer Urethane Co., Ltd. under trademark of Desmodur TT, dicyclohexyldimethylmethane-4,4′-diisocyanate, 2,4-toluenediisocyanate, 2,6-toluenediisocyanate and diphenylmethane-4,4′-diisocyanate. If desired, heterocyclic trimer of two or three kinds of different diisocyanate compounds is also usable. Or, a mixture of said heterocyclic triisocyanates is also usable. Among the above-mentioned polyisocyanates, hexamethylenediisocyanate is preferable. Trimerization of monomer of polyisocyanate compound into isocyanurate may be conducted by any known method.

Suitable amine compound which is the second component for the production of reaction product (b) is amine compound which has primary amino group. Concrete examples of such an amine compound include aralkylamines such as benzylamine; alkylamines such as ethylamine, n-propylamine, sec-propylamine, n-butylamine, sec-butylamine, tert-butylamine, n-pentylamine, α-methylbutylamine, α-ethylpropylamine, β-ethylbutylamine, hexylamine, octylamine, decylamine and stearylamine; cycloalkylamines such as cyclohexylamine; aromatic amines such as aniline; and polyalkylene polyamines such as hexamethylenediamine. These amine compounds may have 55 or less, preferably 1 to 24, much desirably 1 to 12, carbon atoms. Also usable, as amine compound, are compounds which have one or more primary amino group and one or more alkoxy and/or hydroxyl group, examples of which include ethanolamine, 6-aminohexanol, p-methoxybenzylamine, methoxypropylamine, 3,4-dimethoxyphenylethylamine, 2,5-dimethoxyaniline, furfurylamine, tetrahydrofurfurylamine and bis(3-aminopropyl)polytetrahydrofuran (which has a molecular weight of about 750).

The above-mentioned amine compounds may be used either singly or in combination of two or more species.

In the reaction between polyisocyanate compound and amine compound for the production of reaction product (b), one of polyisocyanate compound and amine compound may be used in stochiometric excess. In that case, the ratio of the number of amino groups of amine compound to the number of isocyanate groups of polyisocyanate compound is in a range of 0.7 to 1.5, preferably 0.9 to 1.1.

This reaction between polyisocyanate compound and amine compound is generally conducted by mixing these reaction components with each other and, if necessary, raising temperature. This reaction is preferably carried out at a temperature of 10 to 150° C., much desirably 20 to 80° C. Although reaction components may be mixed by any method, it is generally desirable to add polyisocyanate compound to amine compound. If necessary, the addition process may be divided into several steps. Said reaction is usually carried out in the presence of an organic solvent, e.g., acetone, methylisobutylketone, 1-methoxy-propanol-2, benzene, toluene, xylene and aliphatic hydrocarbon solvent such as petroleum ether.

Crosslinked polymer fine particles (D-2) may be internally crosslinked particulate polymer which is hardly or not at all soluble in, or hardly or not at all compatible with, the above-mentioned base resin component (A), curing agent component (B), thixotropic properties-giving component (C) and organic solvent, and which is stably dispersible in the present composition.

As crosslinked polymer fine particles (D-2), there is usable any known internally crosslinked particulate polymer which is obtained by aqueous emulsion- or aqueous suspension-polymerization or by non-aqueous dispersion polymerization. Among the above, internally crosslinked particulate polymer which is obtained by aqueous emulsion- or aqueous suspension-polymerization is preferably used for the present invention, either after separated in the form of solids by physical or chemical means such as the evaporation or azeotropy of water and the precipitation or flocculation of polymer (particles), or directly, i.e., after water is replaced with other resin or organic solvent as a medium of the desired crosslinked particulate polymer.

As crosslinked polymer fine particles (D-2), there is suitably used such crosslinked polymer fine particles as disclosed in U.S. Pat. No. 5,348,998 which are obtained by emulsion polymerization of polymerizable monomer which has at least two radically polymerizable unsaturated monomer in the presence of a reactive emulsifier which contains allyl group in molecule, In this case, polymer fine particles are internally crosslinked by polymerizable monomer which has at least two radically polymerizable unsaturated groups in molecule.

Also usable as crosslinked polymer fine particles (D-2) is a dispersion of gel polymer fine particles which are obtained by both copolymerization and crosslinking reaction of a mixture of vinyl monomers which have at least 0.5% by weight of at least two kinds of vinyl monomers which have respectively complementary functional groups which are reactive with, and bindable to, each other, in the presence of a mixture of macromonomer (a) which has a molecular chain of poly(12-hydroxystearic acid) and which has, on average, at least about one polymerizable unsaturated double bond per molecule and macromonomer (b) which is a copolymer of ethylenically unsaturated monomers and which has a solubility parameter (SP value) of 7.5 to 9.2 and which has, on average, about 1.0 to about 1.5 polymerizable unsaturated double bonds per molecule, in an organic solvent which dissolves macromonomer (a), macromonomer (b) and said vinyl monomers but which does not substantially dissolve polymer of said vinyl monomers. Said crosslinked polymer fine particles are already known, as minutely .disclosed in U.S. Pat. No. 5,077,347. As macromonomer (a), there is suitably used macromonomer which has about 1 to about 10 polymerizable unsaturated double bonds per molecule, and which is obtained by adding polymerizable unsaturated carboxylic acid to a pendant epoxy group-containing copolymer which is prepared by graft copolymerization or block copolymerization of a polymerizable unsaturated group-containing reaction product obtained by adding epoxy group-containing polymerizable unsaturated compound to terminal carboxyl group of poly(12-hydroxystearic acid) with a polymerizable unsaturated monomer mixture which has an epoxy group-containing polymerizable monomer. In particular preferable is macromonomer which has one polymerizable unsaturated double bond per molecule, and which is obtained by adding epoxy group-containing polymerizable unsaturated compound to terminal carboxyl group of poly(12-hydroxystearic acid). Macromonomer (b) has preferably a number average molecular weight in a range of 3000 to 20000 and a hydroxyl value in a range of 45 to 150 mgKOH/g. As examples of combination of complementary functional groups, there can be mentioned epoxy group/carboxyl group, alkoxysilyl group/hydroxyl group, epoxy group/phosphoric acid group, and isocyanate group/hydroxyl group.

The above-mentioned crosslinked polymer fine particles (D-2) have a high crosslinkage density, and are substantially non-bloating and non-fusing even in an organic solvent having large polymer-dissolving power such as toluene and ethyl acetate. Hence, when compounded with the present composition which contains an organic solvent, said crosslinked polymer fine particles (D-2) give a solution (dispersion) which has a high resin content, i.e., a high solids content, while causing almost no increase in the viscosity of the present composition. Furthermore, in the present composition with which crosslinked polymer fine particles (D-2) have been blended, both fine particles and binder resin form a cured film. Usually, crosslinked polymer fine particles have suitably an average particle size of about 0.01 to 2 μm, in particular in a range of 0.05 to 0.5 μm. When particle size falls within this range, there can be formed a coating film which is excellent in both sag-preventing effect and coating film appearance.

Rheology controlling agent (D), when blended, is capable of giving much more thixotropic properties to the present composition, with the effective result that the occurrence of coating film deficiencies such as sagging and cissing is prevented when the composition is to be applied to vertical substrate or when the composition is to be baked after applied to vertical substrate, and that a coating film with good appearance can be formed.

As for the compounding proportion of rheology controlling agent (D), it is suitably in a range of 0 to 10 parts by weight, in particular 0.5 to 5 parts by weight, per 100 parts by total weight of component (A) and component (B) on solids content basis.

(E) Curing Catalyst:

The present composition may further comprise (E) curing catalyst in addition to (A) a base resin component, (B) a curing agent component and (C) a thixotropic properties-giving component.

Curing catalyst (E) serves to accelerate crosslinking reaction of coating film which is caused by base resin component (A) and curing agent component (B). Concrete examples of this curing catalyst include organotin compound such as tin octylate, dibutyltin di(2-ethylhexanoate), dioctyltin di(2-ethylhexanoate), dioctyltin diacetate, dibutyltin dilaurate, dibutyltin oxide, monobutyltin trioctate, 2-ethyl hexanoate lead and zinc octylate. Also usable are p-toluene sulfonic acid, dodecylbenzene sulfonic acid, dinonylnaphthalene sulfonic acid, dinonylnaphthalene disulfonic acid, butylphosphoric acid, octylphosphoric acid and amine-neutralized matter of these acids. The amount of curing catalyst (E) to be used may be varied according to the purpose of use of the present composition. Generally, however, curing catalyst (E) preferably accounts for 0.005 to 5 parts by weight, in particular 0.01 to 3 parts by weight, per 100 parts by total weight of component (A) and component (B).

The present composition comprises base resin component (A), curing agent component (B) and thixotropic properties-giving component (C) as essential ingredients, and, if necessary, may further comprise rheology controlling agent (D) and/or curing catalyst (E). In addition to these components, the present composition may further comprise solid color pigment, metallic pigment, iridescent pigment, extender pigment, ultraviolet absorber, photostabilizer, anti-settling agent, coated surface regulator and other additives for paint. These components are uniformly blended in an organic solvent to give the present composition.

Examples of solid color pigment include organic pigment of quinacridone type such as quinacridone red, of azo type such as pigment red, of phthalocyanine type such as phthalocyanine blue, phthalocyanine green and perylene; and inorganic pigment such as titanium oxide, carbon black, etc. Examples of metallic pigment include aluminum powder, deposited aluminum powder, alumina powder, nickel powder, copper powder, brass powder and chromium powder. Examples of iridescent pigment include pearl mica powder of iridescent luster, colored pearl mica powder of iridescent luster, etc.

The present composition is usable as a high-solids coating composition of organic solvent type. Examples of usable organic solvent include various kinds for paint such as aromatic or aliphatic hydrocarbon solvent, alcohol solvent, ester solvent, ketone solvent and ether solvent. The coating composition of the present invention is usable with a solids content as high as 70% by weight or more when applied, in particular 75 to 90% by weight.

When polyisocyanate comound (B-1) is to be used as curing agent component (B) in the present composition, since said polyisocyanate comound (B-1) easily reacts with base resin component (A) or the like at room temperature, this polyisocyanate comound (B-1) is preferably separated from base resin component (A) until immediately before the present composition is used, or, in other words, the present composition is suitably used in two-pack system, in which case these two components are mixed with each other immediately before use (application). Components other than base resin component (A) and polyisocyanate comound (B-1) may be formulated with the side of base resin component (A) or, otherwise, may constitute the third package in consideration of their reactivity with polyisocyanate compound.

The present composition is so low-viscous as to be applicable even when solids content at the time of application is 70% by weight or more that it can be applied easily by a coating method such as airless spray, air spray and rotary atomizing spray. These coating methods may be conducted by applying electrostatic voltage. The present composition is readily atomized by these coating methods, and is capable of being applied to a large thickness (as a cured coating film) of 50 μm or more, in particular 60 to 100 μm, by a single application. Furthermore, the present composition is capable of forming a coating film which excels in smoothness, distinctness-of-image gloss and fatness.

It is also acceptable to apply the present composition after it is heated to 30 to 80° C., preferably 40 to 60° C. As a heating method, there are four ways as follows: composition (i) which contains base resin component (A) and composition (ii) which contains curing agent component (B) are each previously heated before mixed with each other; composition (i) alone is heated before mixed with composition (ii); composition (ii) alone is heated before mixed with composition (i); composition (i) and composition (ii) are previously mixed with each other before heated. The above-mentioned heating may sometimes shorten the pot life of the present composition. This problem of pot life can be evaded by homogeneously mixing the compositions with a two-pack paint mixing apparatus (e.g., Precision Mix made by GRACO CO.) after heating. For example, A-liquid tank of this apparatus is filled with composition (i) and B-liquid tank of this apparatus is filled with composition (ii), and, then, A-liquid tank is heated to 55° C., while B-liquid tank is kept at room temperature. Then, with use of this two-pack paint mixing apparatus, composition (i) and composition (ii) are mixed with each other, and, thus, there is obtained the present composition which has a liquid temperature of 40° C. Composition (i) and composition (ii) may be heated also in reverse way. The above-mentioned heating lowers the viscosity of the present composition when applied, with the result that the present composition as a high-solids paint further improves in coatability.

The present composition is usable not only as a clear paint but also as a solid color paint, a metallic paint and an iridescent paint into which coloring pigment, metallic pigment and iridescent pigment have respectively been compounded. The present composition is capable of forming a cured coating film which excels, in particular, in acid resistance, scratch resistance and appearance (e.g., gloss, fatness and distinctness-of-image gloss). Hence, the present composition is preferably usable as the uppermost clear paint in a multi-layer coating film which is composed of at least one colored paint and at least one clear paint which are applied in order.

### THE PRESENT METHOD

The following is an explanation of the present method, i.e., a method of forming a multi-layered coating film which comprises at least one layer of colored coating film and at least one layer of clear coating film, wherein the uppermost layer of clear coating film is formed by the application of the present composition.

In the formation of a multi-layered coating film by the present method, the present composition is used as clear paint for the uppermost layer in the following manners.

Manner (a): In 2-coat method wherein colored paint and clear paint are applied in order, the present composition is used as clear paint.

Manner (b): In 3-coat method wherein colored paint, first clear paint and second clear paint are applied in order, the present composition is used as second clear paint.

Manner (c): In 3-coat method wherein first colored paint, second colored paint and clear paint are applied in order, the present composition is used as clear paint.

These Manners (a), (b) and (c) are explained in more detail.

In Manner (a), examples of colored paint include solid color paint, metallic paint and iridescent paint.

In the above-mentioned colored paint, binder resin component comprises at least one species of base resin such as acrylic resin, vinyl resin, polyester resin, alkyd resin and urethane resin which have crosslinkable functional group (e.g., hydroxyl group, epoxy group, carboxyl group and alkoxysilyl group) and at least one species of crosslinking agent component by which to crosslink and cure said base resin, such as alkyletherified melamine resin, urea resin, guanamine resin, polyisocyanate compound which may be blocked, epoxy compound and carboxyl group-containing compound. In preferable use, base resin accounts for 50 to 90%, and crosslinking agent component accounts for 50 to 10%, on the basis of total weight of base resin and crosslinking agent. For the colored paint, there may be used the above-mentioned coloring pigment, metallic pigment and iridescent pigment. These pigments may be used either separately or in combination of at least two species. Colored paint may be either of organic solvent type or of aqueous type.

Manner (a) can be conducted by 2-coat-1-bake method (2C1B) or 2-coat-2-bake (2C2B) method wherein metal-made or plastic-made substrate for automobile body panel or the like is directly (or after primer coating such as cationically electrodepositable coating, and, if necessary, intermediate coating as well, are applied and cured) coated with the above-mentioned colored paint by a coating method such as airless spray, air spray and rotary atomizing spray (optionally electrostatically) to a thickness, as a cured film, of about 10 to about 50 μm. The resulting coating film is, either after heated at about 100 to about 180° C., preferably about 120 to about 160° C., for about 10 to about 40 minutes and cured, or after left to stand still at room temperature for a few minutes or preheated without curing, coated with clear paint which comprises the present composition by a similar coating method to a thickness, as a cured film, of about 10 to about 70 μm. The resulting coating film is heated at about 100 to about 180° C., preferably about 120 to about 160° C., for about 10 to about 40 minutes, and thus crosslinked and cured.

In Manner (b), colored paint may be of the same species as explained in Manner (a). For first clear paint (the present composition is also usable) which is a paint for forming clear coating film, there may be used a paint which is prepared by removing most or all of pigment from colored paint. As second clear paint, a clear paint which comprises the present composition is used. Manner (b) can be conducted by 3-coat-1-bake method (3C1B), 3-coat-2-bake (3C2B) method or 3-coat-3-bake (3C3B) method wherein colored paint is applied by the same method as in Manner (a), and the resulting coating film is, either after cured, or after left to stand still at room temperature for a few minutes or preheated without curing, coated with first clear paint by a similar coating method to a thickness, as a cured film, of about 10 to about 50 μm. The resulting coating film is, either after heated at about 100 to about 180° C., preferably about 120 to about 160° C., for about 10 to about 40 minutes and cured, or after left to stand still at room temperature for a few minutes or preheated without curing, coated with second clear paint which comprises the present composition by a similar coating method to a thickness, as a cured film, of about 10 to about 50 μm. The resulting coating film is then heated at about 100 to about 180°C., preferably about 120 to about 160° C., for about 10 to about 40 minutes and cured.

In Manner (c), the same kind of colored paint as explained in Manner (a) is usable as first colored paint. Second colored paint is to be applied on the surface of applied first colored paint. For this second colored paint, there is used a colored clear paint which has such a small hiding power that, through the coating film of second colored paint, the color tone (solid color, metallic color or iridescent color) of the surface of the applied first colored paint can be observed. Hence, the hiding power of second colored paint is usually smaller than that of first colored paint. The coating film of second colored paint is coated with clear paint. For this clear paint which is a paint for forming clear coating film, the present composition is used. Manner (c) can be conducted by 3-coat-1-bake method (3C1B), 3-coat-2-bake (3C2B) method or 3-coat-3-bake (3C3B) method wherein, as a colored paint, first colored paint is applied by the same method as in Manner (a), and the resulting coating film is, either after cured, or after left to stand still at room temperature for a few minutes or preheated without curing, coated with second colored paint to a thickness, as a cured film, of about 10 to about 50 μm. The resulting coating film is, either after heated at about 100 to about 180° C., preferably about 120 to about 1600° C., for about 10 to about 40 minutes and cured, or after left to stand still at room temperature for a few minutes or preheated without curing, coated with clear paint which comprises the present composition by a similar coating method to a thickness, as a cured film, of about 10 to about 50 μm. The resulting coating film is then heated at about 100 to about 180° C., preferably about 120 to about 160° C., for about 10 to about 40 minutes and cured.

As stated above, the present composition is a high-solids coating composition which essentially comprises:

as base resin component (A), hydroxyl group-containing compound (A-1) which is obtained from a reaction between carboxyl group-containing compound and epoxy group-containing compound, and which has a weight average molecular weight of 1000 or less and a hydroxyl value of 200 to 800 mgKOH/g, and/or hydroxyl group-containing resin (A-2) which has a weight average molecular weight of 500 to 6000 and a hydroxyl value of 50 to 600 mgKOH/g,

as curing agent component (B), polyisocyanate compound (B-1) and/or melamine resin (B-2), and

as thixotropic properties-giving component (C), organic clay type thickening agent and/or silica fine particles, and, if necessary, further comprises another rheology controlling agent (D) and/or curing catalyst (E). This composition is in particular excellent in atomization by coating with fogging method, and is capable of being applied to a large thickness (as a cured coating film) of 50 μm or more, in particular 60 to 100 μm, by a single application. Furthermore, the present composition is capable of forming a coating film which excels in smoothness, distinctness-of-image gloss and fatness. Coating film which is formed from the present composition is free from the occurrence of popping (foaming), and is capable of preventing etching or stains which are caused by acid rain. Furthermore, car-washing machine makes almost no scratches on coating film of the present composition. Thus, the present composition is in particular useful as a paint for forming automobile uppermost top coating film.

In the following, this invention is explained in more detail by means of Examples and Comparative Examples. Part and % are based on weight. The thickness of coating film means the thickness of cured film.

### 1. SAMPLE PREPARATION

1) Component (A-1)

A reactor equipped with stirrer, cooler, temperature controller, nitrogen-introducing tube and dropping funnel was fed with 296 parts of dimethylolbutanoic acid. The air in the reactor was replaced with nitrogen, and, then, said dimethylolbutanoic acid was heated to 120° C., to which 490 parts of “Cardura E10” was added dropwise over a period of two hours, with the temperature maintained at 120° C. When acid value became 9 or lower, the reaction was terminated. Thus obtained hydroxyl group-containing compound had a solids content of about 98%, a Gardner-Holdt viscosity (20° C.) of Z₆Z₇, a hydroxyl value of 428 mgKOH/g, a number average molecular weight of 600 and a weight average molecular weight of 610.

2) Component (A-2)

A reactor equipped with stirrer, cooler, temperature controller, nitrogen-introducing tube and dropping funnel was fed with 616 parts of ethyl-3-ethoxypropionate. The air in the reactor was replaced with nitrogen, and, then, said ethyl-3-ethoxypropionate was heated to 150° C. and was kept at this temperature. To thus heated matter, a mixture of 220 parts of styrene, 880 parts of isobutylmethacrylate, 242 parts of butylacrylate, 330 parts of 2-ethylhexylacrylate, 418 parts of 2-hydroxyethylmethacrylate, 88 parts of 2-hydroxyethylacrylate, 22 parts of acrylic acid and 220 parts of azobisisobutyronitrile was added dropwise over a period of five hours. After this dropwise addition was over, the resultant mixture was matured at 150° C. for 30 minutes, and, thus, there was obtained a hydroxyl group-containing acrylic resin solution which had a solids content of 69% and a Gardner-Holdt viscosity (20° C.) of PQ. This hydroxyl group-containing acrylic resin (solid content) had a hydroxyl value of 100 mgKOH/g, an acid value of 7.2 mgKOH/g, a number average molecular weight of 2050 and a weight average molecular weight of 3070.

3) Component (B-1)

“Desmodur N3300” (Trademark of isocyanurate type of hexamethylenediisocyanate manufactured by Sumika Bayer Urethane Co., Ltd.)

4) Component (B-2)

“Cymel 325” (Trademark of imino group-containing melamine resin manufactured by Mitsui Cytec Co., Ltd.)

5) Component (C)

(C-1): A 225 ml glass-made mayonnaise bottle was fed with 110 parts of glass beads (soda glass beads; particle size: 1.0 to 1.25 mm), 45 parts of component (A-1), 15 parts of “Bentone 34” (trademark of product of Rheox Co.), 40 parts of “SWASOL 1500” (trademark of product of COSMO OIL Co., Ltd.), which were then ground with a paint shaker for one hour. Thus obtained paste had a solids content of about 60% and a content of “Bentone 34” of about 15%. It was confirmed with a granulometer that the paste had been ground to a particle size of 5 μm or less. The amount of (C-1) as compounded which is shown in Table 1 means solid content of “Bentone 34”.

(C-2): A 225 ml glass-made mayonnaise bottle was fed with 110 parts of glass beads (soda glass beads; particle size: 1.0 to 1.25 mm), 30 parts of component (A-1), 10 parts of “Aerosil R805” (trademark of silica fine particles of Nippon Aerosil Co., Ltd.), 60 parts of “SWASOL 1000”, which were then ground with a paint shaker for 90 minutes. Thus obtained paste had a solids content of about 40% and a content of “Aerosil R805” of about 10%. It was confirmed with a granulometer that the paste had been ground to a particle size of 5 μm or less. The amount of (C-2) as compounded which is shown in Table 1 means solid content of “Aerosil R805”.

6) Component (D)

(D-1): “Setalux C-7176 VB-60” (trademark of polyurea compound as a rheology controlling agent of AKZO NOBEL NV)

(D-2): With use of dimethylaminoethanol as a catalyst, glycidylmethacrylate was added to termincal carboxyl group of self-condensation polyester resin having a resin acid value of 30 and a number average molecular weight of about 1800 which had been prepared by the dehydro-condensation of 12-hydroxystearic acid under reflux with toluene by use of methanesulfonic acid as a catalyst, by which to introduce polymerizable double bonds, and, thus, there was obtained mocromonomer (a) which had a solids content of 70% and had about one polymerizable double bond per molecule on the basis of number average molecular weight.

On the other hand, a flask was fed with 174 parts of butyl acetate, and was then refluxed. In this flask, a mixture of 297 parts of 70% mocromonomer (a) solution, 195.9 parts of methylmethacrylate, 18.5 parts of glycidylmethacrylate, 163.0 parts of xylene and 9.6 parts of 2,2′-azobisisobutyronitrile was added dropwise over a period of three hours at uniform rate, and, then, the resultant mixture was matured for two hours. Furthermore, a mixture of 0.05 part of p-t-butyl catechol, 3.8 parts of methacrylic acid and 0.5 part of dimethylaminoethanol was introduced into said flask, and the resultant mixture was allowed to react at 140° C. for about five hours until resin acid value became 0.5, and, thus, there was obtained macromonomer (b) which had a solids content of 50%. Thus obtained macromonomer (b) was a graft polymer which had a first segment derived from poly(12-hydroxystearic acid) and a second segment derived from a copolymer of methylmethacrylate and glycidylmethacrylate, and had, on average, four polymerizable unsaturated double bonds per molecule.

Another flask was fed with 153 parts of xylene, and was then heated to 125° C. In this flask, a mixture of 50 parts of 2-ethylhexylacrylate, 23 parts of n-butylacrylate, 25 parts of 2-hydroxyethylacrylate, 2 parts of acrylic acid and 4.5 parts of t-butylperoctoate was added dropwise over a period of four hours, and, then, the resultant mixture was matured for two hours. Thus obtained acrylic resin varnish had a solids content of 65% and a number average molecular weight of 7000. To 100 parts of this acrylic resin varnish, there were added 2 parts of glycidylmethacrylate, 0.01 part of 4-t-butylpyrocatechol and 0.15 part of tetrabutylammoniumbromide. The resultant mixture was stirred at 115° C. for seven hours, by which to introduce polymerizable double bond into molecule, and, thus, macromonomer (c) was obtained. In this macromonomer (c), the number of introduced double bond was one per molecule on the basis of number average molecular weight, SP value was 8.70 and hydroxyl value was 121 mgKOH/g.

Another flask was fed with 190 parts of heptane, 20 parts of 50% macromonomer (b) solution and 23 parts of 65% macromonomer (c) solution, to which a mixture of 20 parts of 50% macromonomer (b) solution and 23 parts of 65% macromonomer (c) solution, 50 parts of methylmethacrylate, 50 parts of 2-hydroxyethylacrylate, 1.5 parts of glycidylmethacrylate, 0.8 part of methacrylic acid and 2 parts of 2,2′-azobisisobutyronitrile was added dropwise at reflux temperature over a period of five hours, and, then, the resultant mixture was matured for two hours. Subsequently, 0.1 part by weight of dimethylaminoethanol was added, and the resultant mixture was matured for further four hours, and, thus, there was obtained a non-aqueous dispersion of crosslinked polymer fine particles. Thus obtained was a white dispersion which had a solids content of 40% and a particle size of about 160 nm (peak particle size). Particle size was measured by “COULTER N4 Type Submicron Particle Analyzer”. The particles were insoluble in organic solvent such as acetone, ethyl acetate and xylene.

### 2. EXAMPLES AND COMPARATIVE EXAMPLES

Components which had been prepared in the above-mentioned manner were blended according to the compositional make-up and proportion as shown in Table 1, and, thus, organic solvent type high-solids paints (clear paints) were obtained. In Table 1, the amounts of components (A) to (D) to be formulated mean solids contents.

The test of coating film performance (appearance, hardness) was conducted on multi-layered coating film which was obtained in the following manner. A cold-rolled dull steel sheet which had passed through a chemical conversion treatment was coated with epoxy resin type cationically electrodepositable paint (to a film thickness of 25 μm), and was then heat-cured at 170° C. for 30 minutes, and, subsequently, was coated with intermediate paint (“LUGA-BAKE AM”: trademark of polyester resin-melamine resin-type paint of gray color manufactured by Kansai Paint Co., Ltd.) to a film thickness of 30 μm, and was then heat-cured at 140° C. for 30 minutes. The resultant surface of coating films was coated with aqueous metallic paint (“TWX-402”: trademark of acrylic resin-melamine resin-type paint manufactured by Kansai Paint Co., Ltd.) to a film thickness of 18 μm, and was then dried at 80° C. for 10 minutes. The resultant uncured surface was coated with one of high-solids paints (clear paints) of Examples and Comparative Examples as mentioned in Table 1 (whose viscosity had been adjusted to 50 seconds/Ford cup #4/20° C.) by use of airless spray, each to a film thickness of 65 μm by a single application. The resultant coating films were heated at 140° C. for 30 minutes so that both of the coating film of aqueous metallic paint and the coating film of high-solids paint might be cured simultaneously, and, thus, a multi-layered coating film was obtained.

Incidentally, “Solids content at the application” in Table 1 means the solids content of high-solids paint (clear paint) immediately before applied whose viscosity had been adjusted to 50 seconds/Ford cup #4/20° C.

TABLE I

| | | | | | | | Comparative | | | |
|---|---|---|---|---|---|---|---|---|---|---|
| | Examples | | | | | | Examples | | | |
| Component | 1 | 2 | 3 | 4 | 5 | 6 | 1 | 2 | 3 | 4 |
| (A-1) | 35 | 35 | 35 | 35 | 35 | 35 | 35 | 35 | 35 | 35 |
| (A-2) | 15 | 15 | 15 | 15 | 15 | 15 | 15 | 15 | 15 | 15 |
| (B-1) | 40 | 40 | 40 | 40 | 40 | 40 | 40 | 40 | 40 | 40 |
| (B-2) | 10 | 10 | 10 | 10 | 10 | 10 | 10 | 10 | 10 | 10 |
| (C-1) | 1 | | 1 | 1 | | | | | | |
| (C-2) | | 1 | | | 1 | | | | | |
| (D-1) | | | 5 | | 5 | | | 5 | | 5 |
| (D-2) | | | | 5 | | 5 | | | 5 | 5 |
| Test Results | | | | | | | | | | |
| Solid content at | 83 | 83 | 81 | 82 | 80 | 82 | 85 | 84 | 84 | 83 |
| application (%) | | | | | | | | | | |
| Hardness | 13 | 13 | 12 | 13 | 13 | 12 | 11 | 11 | 11 | 12 |
| Appearance | ∘ | ∘ | ⊚ | ∘ | ⊚ | ∘ | x | Δ | Δ | Δ |
| Sag-marginal | 60 | 60 | 80 | 75 | 75 | 75 | 20 | 30 | 30 | 40 |
| thickness | | | | | | | | | | |

Test Method

Solids Content at Application:

Solids content of each composition immediately before application by air spray.

Hardness:

Tukon hardness (20° C.) of the multi-layered coating film on each test panel, which was measured with Tukon microhardness tester (American Chain & Cable Company).

Appearance:

The appearance of surface of multi-layered coating film of test coated sheet was visually evaluated.

⊚: smoothness, gloss and distinctness-of-image gloss were very excellent

◯: smoothness, gloss and distinctness-of-image gloss were good and all right

Δ: some of smoothness, gloss and distinctness-of-image gloss were (was) rather poor

x: some of smoothness, gloss and distinctness-of-image gloss were (was) remarkably poor

Sag-Marginal Thickness:

Aqueous metallic paint (“TWX-402”) was applied to a film thickness of 18 μm, and was then dried at 80° C. for 10 minutes. The resultant uncured surface was coated with high-solids paint (clear paint) of Examples and Comparative Examples as mentioned in Table 1 (whose viscosity had been adjusted to 50 seconds/Ford cup #4/20° C.) by use of airless spray, to a various film thickness. The resultant coating films were each heated at 140° C. for 30 minutes so that both of the coating films of these two paints might be cured simultaneously. With regard to thus obtained multi-layered coating film, the least thickness (μm) of clear coating film where sagging occurred was observed.

1. A high-solids coating composition which characteristically comprises:
(A) at least one species of base resin component which is selected from the group consisting of hydroxyl group-containing compound (A-1) which is obtained from a reaction between carboxyl group-containing compound and epoxy group-containing compound, and which has a weight average molecular weight of 1000 or less and a hydroxyl value of 200 to 800 mgKOH/g, and hydroxyl group-containing resin (A-2) which has a weight average molecular weight of 500 to 6000 and a hydroxyl value of 50 to 600 mgKOH/g,
(B) at least one species of curing agent component which is selected from the group consisting of polyisocyanate compound (B-1) and melamine resin (B-2), and
(C) at least one species of thixotropic properties-giving component which is selected from the group consisting of organic clay type thickening agent and silica fine particles.

2. A coating composition of claim 1 wherein carboxyl group-containing compound is hydroxycarboxyl acid.

3. A coating composition of claim 1 wherein epoxy group-containing compound is an epoxy group-containing ester compound.

4. A coating composition of claim 1 wherein hydroxyl group-containing compound (A-1) has at least two hydroxyl groups per molecule.

5. A coating composition of claim 1 wherein hydroxyl group-containing compound (A-1) has a weight average molecular weight of 300 to 700, and a hydroxyl value of 300 to 600 mgKOH/g.

6. A coating composition of claim 1 wherein hydroxyl group-containing resin (A-2) is selected from the group consisting of hydroxyl group-containing polyester resin and hydroxyl group-containing acrylic resin.

7. A coating composition of claim 1 wherein hydroxyl group-containing resin (A-2) has a weight average molecular weight of 1000 to 5200, and a hydroxyl value of 80 to 200 mgKOH/g.

8. A coating composition of claim 1 wherein base resin component (A) comprises a combination of hydroxyl group-containing compound (A-1) and hydroxyl group-containing resin (A-2).

9. A coating composition of claim 8 wherein base resin component (A) comprises a combination of 30 to 70% by weight of hydroxyl group-containing compound (A-1) and 70 to 30% by weight of hydroxyl group-containing resin (A-2), on the basis of the weight of total solid content of component (A-1) and component (A-2).

10. A coating composition of claim 1 wherein polyisocyanate compound (B-1) has a number average molecular weight of 2000 or less, in particular 200 to 1000.

11. A coating composition of claim 1 wherein polyisocyanate compound (B-1) is selected from aliphatic polyisocyanates and isocyanurates thereof.

12. A coating composition of claim 1 wherein melamine resin (B-2) has a number average molecular weight of 150 to 3000.

13. A coating composition of claim 1 wherein melamine resin (B-2) is a melamine resin which has an imino group.

14. A coating composition of claim 1 wherein curing agent component (B) comprises a combination of polyisocyanate compound (B-1) and melamine resin (B-2).

15. A coating composition of claim 14 wherein curing agent component (B) comprises a combination of 30 to 70% by weight of polyisocyanate compound (B-1) and 70 to 30% by weight of melamine resin (B-2), on the basis of the weight of total solid content of component (B-1) and component (B-2).

16. A coating composition of claim 1 wherein organic clay type thickening agent is organic smectite clay.

17. A coating composition of claim 1 wherein organic clay type thickening agent is either an alkylamine derivative of montmorillonite or an alkylamine derivative of hectorite.

18. A coating composition of claim 1 wherein the surface of particles of silica fine particles has been treated to be hydrophobic.

19. A coating composition of claim 1 which comprises 80 to 20% by weight of base resin component (A) and 20 to 80% by weight of curing agent component (B) on the basis of total weight of solid content of component (A) and component (B).

20. A coating composition of claim 1 which comprises 0.1 to 10 parts by weight of thixotropic properties-giving component (C) per 100 parts by total weight of component (A) and component (B) on solid content basis.

21. A coating composition of claim 1 which further comprises other rheology controlling agent (D) than thixotropic properties-giving component (C).

22. A coating composition of claim 21 wherein rheology controlling agent (D) is selected from the group consisting of polyurea compound (D-1) and crosslinked polymer fine particles (D-2).

23. A coating composition of claim 21 wherein the proportion of rheology controlling agent (D) is 10 parts by weight or less, per 100 parts by total weight of component (A) and component (B) on solid content basis.

24. A coating composition of claim 1 which further comprises curing catalyst (E).

25. A coating composition of claim 1 which is in the form of clear paint.

26. A method for forming a multi-layered coating film which comprises at least one layer of colored coating film and at least one layer of clear coating film, wherein the uppermost layer of clear coating film is formed by the application of a coating composition of claim 1.

27. Articles which have been coated with a coating composition of claim 1.

28. Articles on which a multi-layered coating film has been formed by the method of claim 26.
